(19) United States
(12) Patent Application Publication
(10) Pub. No.: US 2026/0127568 A1
(43) Pub. Date: May 7, 2026

(54) SYSTEMS AND METHODS FOR REMOTE ACTUATION OF A BULK VENDING MACHINE SYSTEM

(71) Applicants: Gary Mills, South Jordan, UT (US); Wayne Varga, South Jordan, UT (US)

(72) Inventors: Gary Mills, South Jordan, UT (US); Wayne Varga, South Jordan, UT (US)

(21) Appl. No.: 19/239,802

(22) Filed: Jun. 16, 2025

Related U.S. Application Data
(60) Provisional application No. 63/660,000, filed on Jun. 14, 2024.

(51) Int. Cl. G06Q 20/18; G06Q 10/087; G06Q 20/40; G07F 9/00

(52) U.S. Cl. CPC G06Q 20/18; G06Q 10/0877; G06Q 20/407; G07F 9/002; G07F 9/006

(57) ABSTRACT

Electronic bulk vending machine assemblies and systems for remote actuation. A method includes receiving an indication that a payment has been processed for a product stored in a vending machine, wherein the vending machine is one of a plurality of vending machines in electronic communication with an electronic vending controller. The method includes providing a notification to the electronic vending controller indicating the payment for the product was processed. The method includes instructing the electronic vending controller to actuate a disbursement mechanism for the vending machine to automatically disburse the product.

### CROSS-REFERENCE TO RELATED APPLICATIONS

This application claims the benefit of U.S. Provisional Application No. 63/660,000, filed Jun. 14, 2025, which is incorporated herein by reference in its entirety, including but not limited to those portions that specifically appear hereinafter, the incorporation by reference being made with the following exception: In the event that any portion of the above-referenced provisional application is inconsistent with this application, this application supersedes said above-referenced provisional application.

### TECHNICAL FIELD

The disclosure relates generally to computer-based communications and particularly to communications between a remote server and an electronic bulk vending machine assembly.

### BACKGROUND

Many in-person retail establishments include coin-operated vending machines that may be utilized to disburse candies, toys, snacks, and other articles. These vending machines typically rely on gravity-fed disbursement to enable the purchased article to fall into a disbursement channel and then be retrieved by a user. These vending machines have a long history of being enjoyed by users of many ages but have seen decreased use as customers have increasingly moved to electronic payment methods and are less likely to have coins or cash on-hand.

Some conventional vending machines have been developed that allow for electronic payment methods. However, these conventional vending machines typically require onsite processing with a credit card or other electronic payment means. These conventional vending machines do not allow for remote management, aggregation, shopping, and payment processing of a plurality of independent vending machines that are located at different geographical locations. Additionally, these conventional vending machines do not allow for aggregating data from a plurality of gravity-fed vending machines and then assessing the data to determine sales metrics for various vending products.

In view of the foregoing, disclosed herein are systems, methods, and devices for automated electronic bulk vending machines, and further for remote management, payment processing, and actuation of the electronic bulk vending machines. The systems, methods, and devices described herein may be leveraged to render a product interface to enable a user to select a vending product through a computing device, and then cause a vending machine to automatically disburse the selected product or enable the user to disburse the selected product.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 is a schematic block diagram of a system for remotely communicating with and actuating an electronic bulk vending machine assembly that includes an electronic vending controller;

FIG. 2 is a schematic block diagram of a system for remotely communicating with and actuating an electronic bulk vending machine assembly that includes an electronic vending controller;

FIG. 3 is a schematic block diagram of a process flow for receiving a product selection, initiating payment processing, and electronically initiating disbursement of a product from an electronic bulk vending machine assembly;

FIG. 4 is a schematic illustration of an exemplary electronic bulk vending machine assembly that includes an electronic vending controller capable of communicating with a server by way of a network interface;

FIG. 5 is a schematic block diagram illustrating exemplary components and functionalities of a device aggregation platform that provides a customer interface and an administrator interface for managing and electronic bulk vending machine assembly;

FIG. 6 is a schematic block diagram of a system and process flow for automatically redirecting to a product interface and then processing an order for a product available at an electronic bulk vending machine assembly;

FIG. 7 is a schematic block diagram of a system and process flow for automatically redirecting to a product interface and then processing an order for a product available at an electronic bulk vending machine assembly;

FIG. 8 is a schematic flow chart diagram of a method flow for automatically redirecting to a product interface and then processing an order for a product available at an electronic bulk vending machine assembly; and

FIG. 9 illustrates components of an example computing device.

### DETAILED DESCRIPTION

Disclosed herein are systems, methods, and devices for facilitating communications between an electronic bulk vending machine and an offsite server. Further described herein are systems, methods, and devices for improved data aggregation and data analysis regarding the sales and disbursement of a plurality of gravity-fed vending machines that are distributed across multiple geographic locations.

Unlike conventional vending machine systems limited to onsite electronic payments or basic remote monitory, the systems, methods, and devices described herein integrate centralized aggregation of numerous vending machines, enable real-time data analytics for sales optimization, and enable remote actuation of vending machines triggered by user-initiated electronic transactions. The systems, methods, and devices described herein provide enhanced scalability and convenience for customers and vending machine administrators, when compared with conventional vending machines known in the art.

Before the systems, methods, and devices described herein are disclosed and described, it is to be understood that this disclosure is not limited to the particular structures, configurations, process steps, and materials disclosed herein as such structures, configurations, process steps, and materials may vary somewhat. It is also to be understood that the terminology employed herein is used for the purpose of describing particular embodiments only and is not intended to be limiting since the scope of the disclosure will be limited only by the appended claims and equivalents thereof.

In describing and claiming the subject matter of the disclosure, the following terminology will be used in accordance with the definitions set out below.

It must be noted that, as used in this specification and the appended claims, the singular forms “a,”“an,”and “the”include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element or step not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether shown or not.

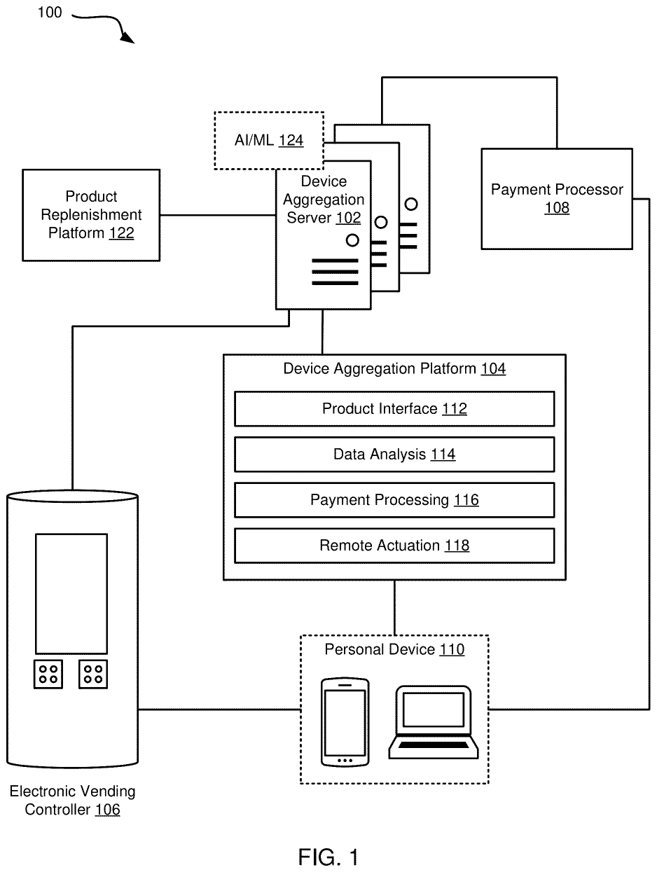

Referring now to the figures, FIG. 1 is a schematic diagram of a system 100 for remotely collecting payment for a vending machine and then actuating the vending machine to disburse products. The system 100 may be implemented to manage a plurality of different electronic vending machines that are located in different geographical locations. The system 100 may further be implemented to actuate multiple vending machines at a single geographical location.

The system 100 includes an electronic vending controller 106 in communication with one or more electronically-actuated vending machines of an electronic bulk vending machine assembly. The electronic vending controller 106 receives and issues instructions for automatically disbursing products from one or more of the electronically-actuated vending machines of the electronic bulk vending machine assembly. The system 100 includes a device aggregation server 102 that renders a device aggregation platform 104, which may include rendering a graphical user interface (GUI) for a customer platform (i.e., a customer-facing GUI) and an administrator platform (i.e., an administrator or owner-facing GUI). The device aggregation server 102 executes software instructions for a product interface 112, data analysis 114, payment processing 116, and remote actuation 118 vending machine units. The system 100 includes a plurality of personal devices 110 in communication with one or more of the electronic vending controller 106, the device aggregation server 102, or an external third-party payment processor 108.

The device aggregation server 102 may securely communicate with one or more third-party service providers, including a payment processor 108 and a product replenishment platform 122. The device aggregation server 102 may integrate with third-party inventory platforms such as SAP or Oracle by way of an API to enable automated reordering when inventory levels drop below determined thresholds. The payment processor 108 may be integrated within the device aggregation platform 104 so the payment processing 116 appears seamless to an end use, even though the payment processing 116 is being executed by a third-party payment processor 108 rather than the device aggregation server 102. The device aggregation server 102 may additionally communicate with a third-party product replenishment platform 122 to automatically generate and place orders for replacement products to be installed within vending machine assemblies. The device aggregation server 102 may integrate with smart city infrastructures to provide anonymized foot traffic data or integrate with public transit for location-based promotions.

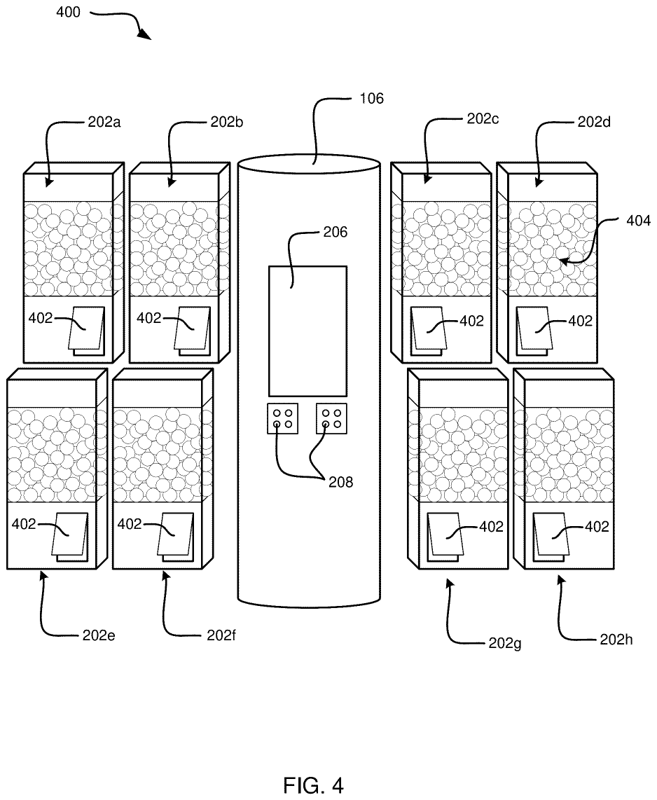

The electronic vending controller 106 is a component of an electronic bulk vending machine assembly that includes a plurality of independent vending machines that each distribute one or more products (see, e.g., the assembly 400 described at least in connection with FIG. 4). The number and size of individual vending machine units may vary, and a plurality of individual vending machines may be controlled by the electronic vending controller 106. The one or more electronic vending controllers 106 are in communication with an offsite computing system such as the device aggregation server 102.

The electronic vending controller 106 includes a microcontroller and memory. The electronic vending controller 106 additionally includes a communication interface enabling the communications over a network by way of Ethernet, Wi-Fi®, cellular, Bluetooth®, and so forth. The electronic vending controller 106 communicates with the plurality of independent vending machines by way of a wire connection, such as a serial interface, or by way of a wireless protocol, such as ZigBee®, Wi-Fi®, or Bluetooth®. The electronic vending controller 106 sends actuation signals, such as electrical pulses or digital commands, to motors or solenoids within the plurality of independent vending machines. The electronic vending controller 106 may include firmware to process incoming notifications and translate those notifications into specific disbursement instructions for any of the plurality of independent vending machines.

The electronic vending controller 106 may receive sensor data output by the plurality of independent vending machines to aid in tracking current product inventory. One or more of the plurality of independent vending machine may be equipped with a sensor for tracking current product inventory levels. The sensor may include an optical sensor to track whether a product has successfully been disbursed from the vending machine. The sensor may include a weight sensor to track the current weight of the products stored within the vending machine. The electronic vending controller 106 may regularly receive data inputs from the vending machine sensors. The electronic vending controller 106 may process the sensor data inputs onsite with the microcontroller, and/or the electronic vending controller 106 may transmit the sensor data inputs to the device aggregation server 102.

The device aggregation server 102 executes instructions for services rendered on the device aggregation platform 104, including product interfaces 112, data analysis 114, payment processing 116, and remote actuation 118. The device aggregation server 102 is a remote computing system hosting the device aggregation platform 104, which is a software suite executed by one or more processors. The device aggregation server 102 manages a plurality of independent vending machines that may be located across diverse geographic locations. The device aggregation server 102 includes redundant storage and network interfaces to ensure reliability and scalability.

The device aggregation server 102 supports horizontal scalability through load-balancing algorithms such as round-robin or least connections to manage traffic across multiple instances during peak usage. The device aggregation server 102 executes real-time inventory synchronization that is achieved through a distributed database architecture to ensure low-latency updates across all vending machines associated with one or more electronic vending controllers 106. The device aggregation server 102 includes redundant server clusters and automatic failover mechanisms to maintain high availability and minimize downtime from hardware or network failures.

The device aggregation server 102 may include or integrate with an artificial intelligence and/or machine learning (AI/ML) 124 algorithm. The AI/ML 124 executes time-series forecasting that may be implemented with an ARIMA or LSTM model to predict demand and optimize restocking schedules for a plurality of vending machines managed by one or more electronic vending controllers 106. The AI/ML 124 assesses user behavior data to identify peak purchasing times and recommend product placements based upon sales patterns. Operators may access these insights by way of the device aggregation platform 106, where insights may be rendered in visualizations with heatmaps and trend charts to enable data-drive decision making.

The device aggregation platform 104 includes a product interface 112. The product interface 112 may differ in its implementation depending on the ownership of the electronic vending controller 106 and the preferred electronic commerce channels for shopping products available at the electronic vending controller 106. In some implementations, the product interface 112 is a user interface rendered by the device aggregation server 102 that displays products available at the electronic vending controller 106. This user interface may be accessible to a user by way of an application or a website. The product interface 112 may provide real-time information pertaining to current products, past products, upcoming products, current inventory availability, current pricing, locations of electronic control vending machines 106, and so forth. The product interface 112 offers real-time feedback to customers such as stock availability notifications and estimated wait times for disbursement. Customers may save favorite products for quick reordering. In some cases, customers may earn loyalty points redeemable for discounts or free items.

In alternative implementations, the product interface 112 is a means of redirecting a personal device 110 to an external website or application to shop products available at the electronic vending controller 106. In some cases, the device aggregation server 102 generates a unique code, such as a QR code, which redirects the personal device 110 to website for the electronic vending controller 106. This unique code may be affixed to the electronic vending controller 106 or rendered by a display on the electronic vending controller 106.

The device aggregation platform 104 provides data analysis 114 for data associated with the electronic vending controller 106. The data analysis 114 may be rendered on a user interface and provide metrics pertaining to, for example, sales history of various locations of electronic control vending machines 106, sales history of various products available at electronic control vending machines 106, sales analysis data pertaining to product sales at certain times and seasons, and so forth.

The device aggregation server 102 executes instructions for payment processing 116. This may include embedding third-party payment processing from a payment processor 108 into a website or application executed by the device aggregation server 102. This may include redirecting a personal device 110 to process payment with the third-party payment processor 108. In alternative implementations, the device aggregation server 102 performs payment processing with necessary security protocols.

The device aggregation server 102 enables remote actuation 118 of a plurality of electronically controlled vending machines in communication with the electronic vending controller 106. The device aggregation server 102 communicates with the electronic vending controller 106 by way of a network connection such as the Internet. The device aggregation server 102 instructs the electronic vending controller 106 to release products from one or more vending machine vessels. The electronic vending controller 106 then actuates one or more robotic vending components to automatically release the products as instructed by the device aggregation server 102.

The device aggregation server 102 may integrate the payment processor 108 into the device aggregation platform 104 by way of an API integration, a hosted payment page, or a plugin or extension. The API integration includes a direct integration with the payment processor's 108 REST API, and this provides full control over the appearance of the device aggregation platform 104, the user experience, and the data flow. In some cases, the device aggregation platform 104 may redirect a user to the payment processor's 108 secure checkout page, and then return the user to the web browser or web application for accessing the device aggregation platform 104. This reduces personal information compliance burdens but offers less customization.

The personal device 110 is any personal computing device that can communicate with the device aggregation server 102, the electronic vending controller 106, the payment processor 108, a website, or a cloud-computing based software application. The personal device 110 may include a smart phone, tablet, laptop, personal computer, and so forth. Personal devices 110 may communicate with the device aggregation server 102 by way of a local area network (LAN), wide area network (WAN), or another network connection. In an embodiment, personal devices 110 can connect to a network, such as a cloud computing network or the Internet, by way of a network connection that may be facilitated by the device aggregation server 102.

The device aggregation server 102 may be located offsite at a location that is remote to the electronic vending controller 106. The device aggregation server 102 may be in communication with a network such as a cloud computing network. In an embodiment, a single server includes the information stored in the device aggregation server 102 and the device aggregation server 102. In an embodiment, the information stored in the device aggregation server 102 includes sensitive information such as personally identifiable information, and the information is therefore encrypted and safeguarded.

The system 100 employs secure communication protocols, including HTTPS for web-based interactions and TLS 1.3 for data encryption. This ensures end-to-end security between the electronic vending controller 106 and the device aggregation server 102. The system 100 utilizes RESTful APIs for efficient data exchange and implements token-based authentication to prevent unauthorized access. In case of network disruptions, local caching and queuing mechanisms maintain transaction integrity and service continuity.

The system 100 supports over-the-air (OTA) updates for the electronic vending controller 106 and the device aggregation server 102. This enables seamless feature enhancements and security enhancements. The OTA updates provide a modular architecture that adapts to new payment methods (e.g., biometric authentication) or interaction models (e.g., gesture control).

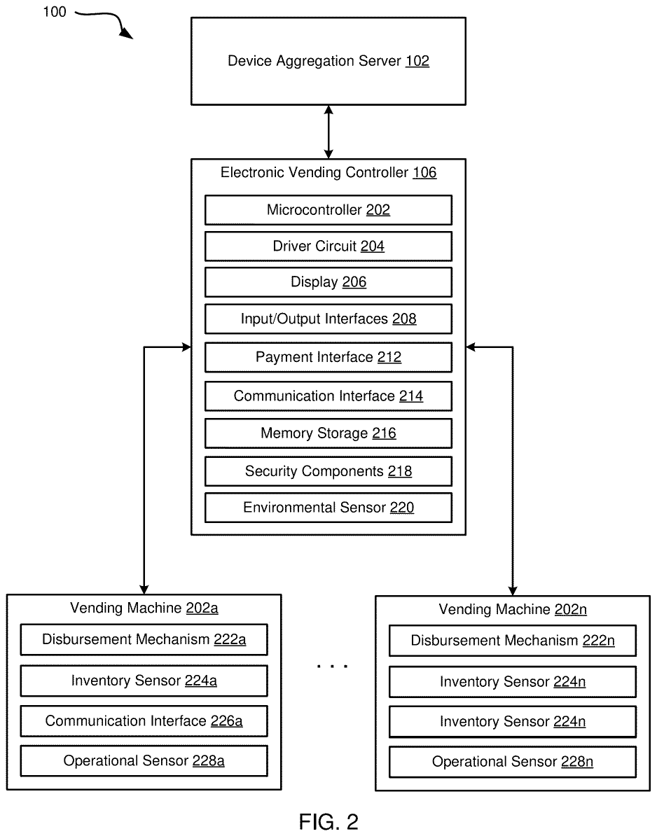

FIG. 2 is a schematic block diagram of components of the system 100 for remotely collecting payment for a vending machine and then actuating the vending machine to disburse products. FIG. 2 specifically illustrates components of the electronic vending controller 106 that communicates with the device aggregation server 102. FIG. 2 further illustrates components of a plurality of vending machines 202a-202n that communicate with the electronic vending controller 106.

The electronic vending controller 106 includes one or more of a microcontroller 202, motor driver circuit 204, display 206, input/output interfaces 208, payment interface 212, communication interface 214, memory storage 216, security components 218, or environmental sensors 220. The electronic vending controller 106 is in communication with one or more independent vending machines 202a-202n that may each include a disbursement mechanism 222a-222n, inventory sensor 224a-224n, communication interface 226a-226n, and operational sensor 228a-228n. The electronic vending controller 106 utilizes energy-efficient components, like a low-power microcontroller 202, and sleep modes, to reduce power consumption.

The microcontroller 202 of the electronic vending controller 106 is the main processing unit for the electronic vending controller 106. The microcontroller 202 executes control software, manages operations, and coordinates other components.

The driver circuit 204 of the electronic vending controller 106 controls disbursement mechanisms 222a-222n for product delivery. The driver circuit 204 is an electronic interface that sits between the microcontroller 202 and a component of a disbursement mechanism 222a-222n of a vending machine 202a-202n to control operation of the disbursement mechanism 222a-222n. The driver circuit 204 may include power amplification abilities to convert low-power control signals from the microcontroller 202 into high-power signals needed by the disbursement mechanisms 222a-222n. The driver circuit 204 may include a DC motor driver for simple on/off and direction control. The driver circuit 204 may include a stepper motor driver for precise positioning with step-by-step control. The driver circuit 204 may include a servo motor driver for position feedback control. The driver circuit 204 include a brushless DC driver for more complex electronic commutation.

The display 206 of the electronic vending controller 106 provides a means for a user to interact the electronic vending controller 106. The display 206 may display information regarding current product selections, current product inventory, current pricing, means for contact technical support or customer support, means for setting up an account, means for downloading an application for placing orders, means for placing an order, means for providing payment, and so forth. The display 206 may specifically render a version of the device aggregation platform 104 as executed by the device aggregation server 102. The display 206 may include a touchscreen display and may display the product interface 112 for selecting one or more products from the vending machines 202.

The input/output interfaces 208 of the electronic vending controller 106 provide a means for a user to provide inputs to the electronic vending controller 106. The input/output interfaces 208 may include one or more of physical buttons or keys, a mouse or trackpad, a touchscreen, a microphone, a camera, a barcode or QR code scanner, a joystick or game controller, a card reader, a keypad, a switch or button, and so forth.

The payment interface 212 of the electronic vending controller 106 may include an electronic payment system to retrieve payment information from a card or mobile wallet. The payment interface 212 may include one or more of a magnetic stripe card reader, a chip card reader, and/or a contactless payment module comprising an NFC or RFID means for collecting payment from tap-to-pay cards and mobile wallets. The payment interface 212 may include a PIN pad comprising a secure keypad for PIN entry. The payment interface 212 may include a payment processing unit for encrypting and processing transaction data, and may further include a communication module for connect to payment networks by way of cellular, Wi-Fi®, or Ethernet®. The payment interface 212 may include a digital interface including one or more of a code scanner for mobile payment apps and digital wallets, a mobile payment integration comprising an API for Apple Pay®, Google Pay®, Samsun Pay®, and so forth, and a Bluetooth® module for application-based payments and customer interaction.

The payment interface 212 may include security components including encryption hardware for securing payment data transmissions, tamper detection sensors for detecting unauthorized access attempts, security key storage hardware for storing cryptographic keys, and anti-skimming devices for protecting card readers from fraudulent attachments. The payment interface 212 may include a payment controller that coordinates payment methods, validates transactions, and communicates successful payment to the microcontroller 202. The payment interface 212 may include a display interface, means for audio feedback, and status LEDs.

The communication interface 214 of the electronic vending controller 106 enables the electronic vending controller 106 to electronically communicate with the device aggregation server 102 and the one or more vending machines 202a-202n. The communication interface 214 may include means for wired communication between the microcontroller 202 and vending machines 202a-202n. The communication interface 214 may include means for wireless communication between the microcontroller 202 and vending machines 202a-202n such as Wi-Fi®, Bluetooth®, and so forth. The communication interface 214 may include means for wireless communication between the microcontroller 202 and the device aggregation server 102, such as Ethernet®, Wi-Fi®, cellular modem (3G/4G/5G), Bluetooth®, and so forth.

The memory storage 216 of the electronic vending controller 106 provides a means to store sensor data, inventory tracking data, payment transaction data, product data, and so forth that may be provided to and/or received from the device aggregation server 102. The memory storage 216 may include flash memory for firmware and configuration. The memory storage 216 may include EEPROM for transaction logs and settings. The memory storage 216 may include RAM for storing operational data.

The security components 218 of the electronic vending controller 106 ensure payment transactional information, product information, inventory tracking information, sensor data, and other information is stored securely. The security components 218 may include encryption chips for payment processing, tamper detection circuits, and secure key storage modules.

The environmental sensor 220 of the electronic vending controller 106 may be utilized to monitor the status, functionality, and current inventory of the vending machine assembly. The environmental sensor 220 may include a temperature sensor to determine the current surrounding temperature, and this information may be utilized to determine whether certain products should be refrigerated. The environmental sensor 220 may include an optical sensor, camera, or motion detection sensor for security.

The disbursement mechanisms 222a-222n of the vending machines 202a-202n may vary depending on the types of products being disbursed. The disbursement mechanisms 222a-222n may include one or more of a gravity feed with gate control, spiral dispenser, drop shelf system, pusher mechanism, conveyer belt system, lift system, rotating drum system, or robotic pick-and-place. The gravity feed with gate control stacks products vertically and holds the products by a controllable gate or stopper, and when selected, the gate opens to release one or more products. The spiral dispenser includes a rotating metal spiral, wherein products sit between coil turns of the metal spiral, and rotation of the metal spiral causes a product to fall into a delivery chute. The drop shelf system includes a shelf for holding products, and retraction or tilting of the shelf causes products to drop into a collection area. The pusher mechanism includes a mechanical arm or paddle for pushing products forward from the back of a column such that products fall into a delivery chute. The conveyor belt system moves products along a belt system to a dispensing point. The lift system is configured to lift products from a storage position and transport them to a delivery door. The rotating drum system holds products within compartments within a rotating cylinder and rotates the drum to align a selected product with an exit chut. The robotic pick-and-place uses robotic arms to grab and place products.

The disbursement mechanisms 222a-222n may specifically include the gravity feed with gate control system. The position of the gate may be remotely controlled by the microcontroller 202 and driver circuit 204.

The inventory sensors 224a-224n of the vending machines 202a-202n are utilized to monitor current inventory levels and determine whether products are successfully dispersed. The inventory sensors 224a-224n provide sensor data to the microcontroller 202 of the electronic vending controller 106. The microcontroller 202 may assess the sensor data onsite and/or provide the sensor data to the device aggregation server 102. The inventory sensors 224a-224n may include one or more of infrared beam sensors, weight sensors, optical sensors, cameras, ultrasonic distance sensors, capacitive proximity sensors, magnetic sensors, RFID/NFC sensors, photoelectric sensors, pressure sensors, inductive sensors, or multi-sensor arrays.

The vending machines 202a-202n may include one or more infrared beam sensors including a transmitter and receiver pair. The transmitter/receiver pair creates a light beam across a dispensing path. When a product falls and breaks the beam, the system may decrement an inventory count. The vending machines 202a-202n may additionally or alternatively include photoelectric sensors utilizing light beams (visible or infrared) to detect product presence. These may be configured for through-beam, retroreflective, or diffuse sensing modes.

The vending machines 202a-202n may include weight sensors comprising strain gauge-based sensors to measure the weight of product. Changes in weight indicate changes in inventory levels, and these sensors may be utilized to detect multiple items dispensed simultaneously and provide accurate remaining quantities. The vending machines 202a-202n may additionally or alternatively include pressure sensors to detect when products are dispensed by measuring force changes on dispensing mechanisms or collection areas.

The vending machines 202a-202n may include optical sensors or cameras. These sensors may be processed with image processing software to visually count product inventory. The optical sensors or cameras may be utilized to identify certain products, detect empty slots, and handle mixed inventory.

The vending machines 202a-202n may include ultrasonic distance sensors that measure the distance to the top of a product stack by utilizing sound waves. Data output by these sensors may be assessed to calculate inventory levels based upon known product dimensions.

The vending machines 202a-202n may include capacitive proximity sensors that detect changes in capacitance when products are present or absent. These may be useful for detecting product presence without physical contact.

The vending machines 202a-202n may include magnetic sensors (such as Hall Effect sensors), radio-frequency identification (RFID) sensors, or near field communication (NFC) sensors. These sensors may interact with product tags to track specific items. The magnetic sensors may detect magnetic fields from products with magnetic tags or metallic components. The RFID/NFC sensors may read product tags to track specific items, and then provide detailed inventory data including expiration dates, product identification, and so forth. The vending machines 202a-202n may additionally or alternatively include inductive sensors that detect metallic products or components through electromagnetic fields.

The vending machines 202a-202n may include one or more of any of the inventory sensors 224a-224n described herein. One or more of the vending machines 202a-202n may include two or more types of inventor sensors 224a-224n to form a multi-sensor array. The multi-sensor array combines different sensor types to provide redundancy and improved accuracy. For example, a weight a pressure sensor may be combined with an optical sensor or camera sensor to provide increased confidence in inventory levels.

The communication interfaces 226a-226n of the vending machines 202a-202n enable the vending machines 202a-202n to electronically communicate with the electronic vending controller 106. The communication interface 214 may include means for wired communication between the microcontroller 202 and the vending machines 202a-202n. The communication interface 214 may include means for wireless communication between the microcontroller 202 and vending machines 202a-202n such as Wi-Fi®, Bluetooth®, and so forth.

The vending machines 222a-222n may each include one or more operational sensors 228a-228n. The operational sensors 228a-228n may include one or more of temperature sensors, vibration sensors, and weight sensors to continuously monitor operational health of a vending machine. The electronic vending controller 106 processors the operational sensors 228a-228n data to detect anomalies like overheating or product jams. The electronic vending controller 106 automatically generates maintenance alerts that are transmitted to the device aggregation server 102 and may be forwarded to vending machine administrators via the device aggregation platform 104. Administrators may perform remote diagnostics through the device aggregation server 102 by accessing real-time logs and running troubleshooting scripts to resolve issues without onsite intervention.

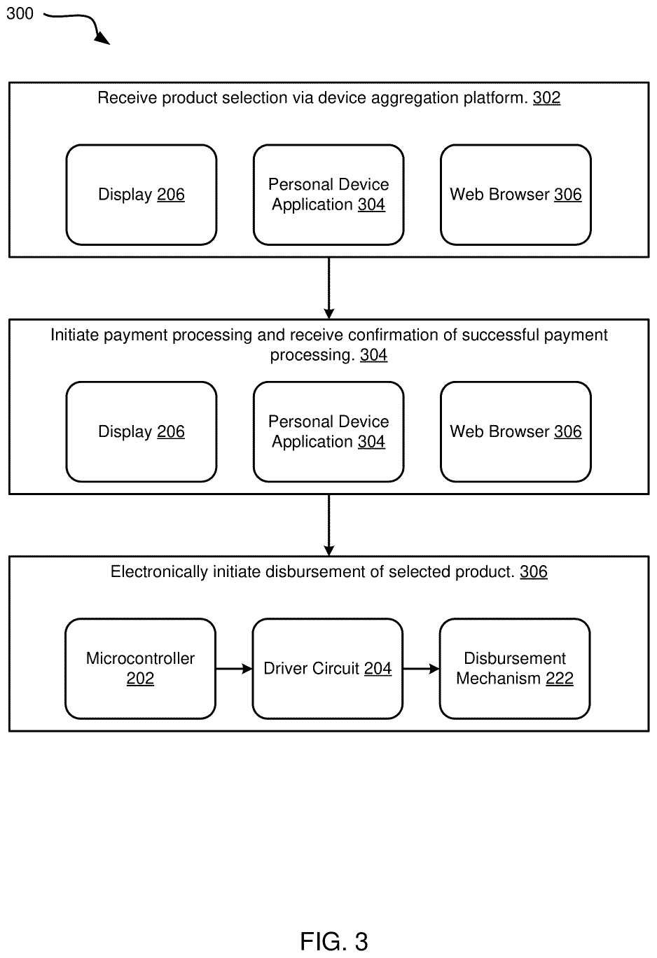

FIG. 3 is a schematic block diagram of a process flow 300 for receiving a product selection, processing payment, and automatically disbursing a product with an electronic vending machine system. The process flow 300 is executed by components of the system 100 described at least in connection with FIGS. 1 and 2, including the device aggregation server 102, the electronic vending controller 106, and one or more vending machines 202a-202n.

The process flow 300 includes receiving at 302 a product selection via the device aggregation platform 104. The device aggregation platform 104 is rendered on the device aggregation server 102 on one or more of the display 206 of the electronic vending controller 106, a personal device application 304 running on a personal device 110, or a web browser 306 running on a personal device 110. The device aggregation platform 104 displays product options to a user, and the user may select the desired product(s) on the device aggregation platform 104.

The process flow 300 includes initiating at 304 payment processing and then receiving confirmation of successful payment processing. The device aggregation server 102 determines a total invoice amount based upon the product(s) selected by a customer in step 302. The total invoice amount is rendered on the device aggregation platform 104 that is accessible to the customer by way of one or more of the display 206, personal device application 304, or web browser 306. The device aggregation server 102 integrates with a third-party payment processor 108 to receive payment information, retrieve authorization for the payment, and execute the electronic payment transaction. The customer may provide payment information through the device aggregation platform 104 rendered on any of the display 206, personal device application 304, or web browser 306. The third-party payment processor 108 may be integrated into the device aggregation platform 104 so the process appears seamless to the customer, even though the payment processing is handled by the payment processor 108 rather than the device aggregation server 102.

The device aggregation server 102 may initiate payment processing by providing an invoice amount to the payment processor 108 and then permitting the payment processor 108 to receive payment information from the customer via the device aggregation platform 104. The third-party payment processor 108 may seek authorization for a payment by directly contacting a bank or credit card company for authorization. When the payment is authorized, the payment processor 108 indicates to the device aggregation server 102 that payment is successfully processed.

The process flow 300 includes electronically initiating at 306 disbursement of the selected product(s). In response to receiving confirmation that payment has been successfully processed, the device aggregation server 102 communicates with the electronic vending controller 106 to indicate which product(s) should be disbursed through the vending machine(s) 202a-202n. The microcontroller 202 of the electronic vending controller 106 receives the instructions to disburse product(s), and these instructions are provided to the appropriate vending machine(s) 202a-202n by way of the driver circuit 204. The driver circuit 204 of the electronic vending controller 106 causes one or more disbursement mechanism(s) to release the appropriate product(s).

FIG. 4 is a schematic illustration of an exemplary assembly 400 for an electronic bulk vending machine. The assembly 400 may be remotely controlled and managed by the device aggregation server 102. Products within the assembly 400 may be purchased by a user over a cloud-computing network, and then the products may be automatically dispersed or unlocked by actuating one or more robotic vending components.

The assembly 400 includes the electronic vending controller 106 and additionally includes a plurality of vending machines 202a-202h. The vending machines 202a-202h dispense products such as candies, toys, snacks, electronics, and so forth, using gravity-fed channels, spring-loaded mechanisms, or robotic arms. Each of the plurality of vending machines 202a-202h includes a disbursement box 402 and an electronically controlled actuator (not visible in FIG. 4). The electronically controlled actuator includes one or more of a motor, solenoid, or pneumatic device interfaced with the microcontroller 202 and/or driver circuit 204 of the electronic vending controller 106 by way of a wired or wireless connection. The electronically controlled actuator causes one or more products to be released such that a user may retrieve the one or more products from the disbursement box 402.

The electronic vending controller 106 serves as a central control unit that serves multiple vending machines 202a-202h. The electronic vending controller 106 is in electronic communication with one or more locks, motors, or actuators serving as disbursement mechanisms (see 222 at FIG. 2) disposed within the individual vending machines 202a-202h. Thus, the vending machines 202a-202h may automatically unlock or disburse the product 404 in response to receiving instructions from the electronic vending controller 106.

The vending machines 202a-202h may be equipped with one or more sensors for tracking current inventory levels. One or more of the vending machines 202a-202h may be equipped with one or more of an infrared (IR) sensor, weight sensor, optical sensor, proximity sensor, or radio-frequency identification (RFID) sensor. The vending machines 202a-202h may output sensor data to the electronic vending controller 106 on a regular basis and/or immediately upon disbursing a product or attempting to disburse a product. The electronic vending controller 106 may process the sensor data onsite with the onboard microcontroller. The electronic vending controller 106 may transmit the sensor data to the device aggregation server 102.

In some implementation, the assembly 400 includes one or more of the components or functionalities described in U.S. Pat. No. 6,182,861 B1, issued on Feb. 6, 2001. The entirety of U.S. Pat. No. 6,182,861 B1 is incorporated herein by reference.

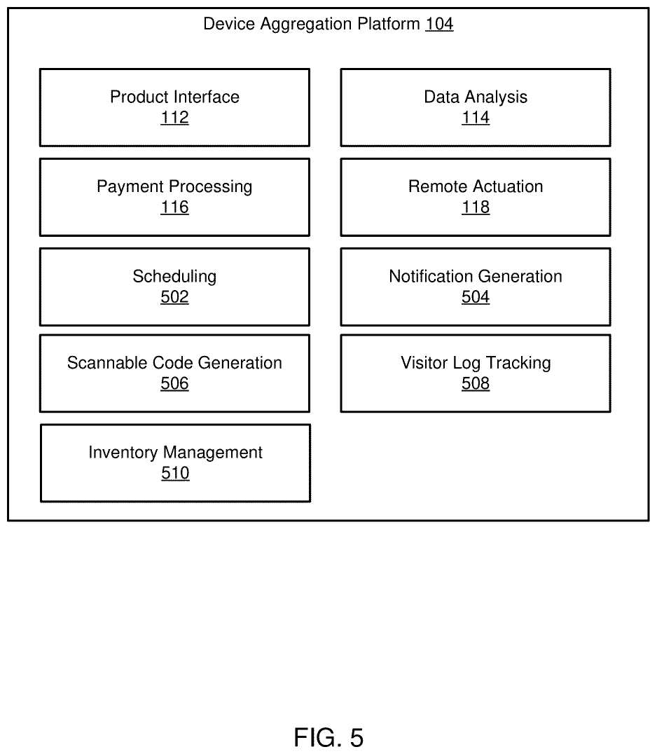

FIG. 5 is a schematic block diagram depicting exemplary components and functionalities of the device aggregation platform 104. The functionalities of the device aggregation platform 104 may be executed by the device aggregation server 102 or another computing resource.

The device aggregation platform 104 provides one or more of a product interface 112, data analysis, payment processing 116, and remote actuation 118 as described at least in connection with FIG. 1. The device aggregation platform 104 additionally may provide one or more of scheduling 502, notification generation 504, scannable code generation 506, visitor log tracking 508, and inventory management 510.

For purposes of illustration, programs and other executable program components are shown herein as discrete blocks, although it is understood that such programs and components may reside at various times in different storage components of a computing device and are executed by one or more processors. Alternatively, the systems and procedures described herein can be implemented in hardware, or a combination of hardware, software, and/or firmware. For example, one or more application specific integrated circuits (ASICs) can be programmed to conduct one or more of the systems and procedures described herein. As used herein, the term “component” is intended to convey the implementation apparatus for accomplishing a process, such as by hardware, or a combination of hardware, software, and/or firmware, for the purposes of performing all or parts of operations disclosed herein. The terms “component” is intended to convey independence in how the modules, components, or their functionality or hardware may be implemented in different embodiments.

The scheduling 502 includes software instructions for scheduling maintenance and refilling of vending machines 202 within the assembly 400. The scheduling 502 monitors inventory based upon data output by one or more sensors installed within the vending machines, such as weight sensors or optical sensors. The scheduling 502 also tracks disbursement counts. The scheduling 502 schedules refilling when inventory drops below a configurable threshold, such as, for example 20% capacity or 10%. The scheduling 502 schedules maintenance or diagnostics when malfunctions are detected. The scheduling 502 initiates a workflow to generate a notification (see notification generation 504) indicating that product needs to be refilled, maintenance needs to be scheduled, or diagnostics need to be performed.

The notification generation 504 includes software instructions for determining when a notification should be generated, and further for generating a notification as needed. The notification generation 504 generates notifications indicating that certain products or vending machines are running low and/or have run out, and thus need to be refilled. The notification generation 504 generates notifications when the assembly 400 requires maintenance or repair. The notification generation 504 triggers an alert for low inventory, mechanical failures, scheduled maintenance, or based upon real-time data from the vending machines 202. The notifications may be sent to operators by way of email, SMS, mobile application notification, phone call, and so forth.

The scannable code generation 506 includes software instructions for generating, retrieving, or reading a scannable code such as a QR code. The scannable code generation 506 component may generate a scannable code that redirects a personal device 110 to an external website or external application to then shop for products available at the assembly 400. The scannable code generation 506 may generate dynamic codes (e.g., QR codes or similar) unique to each vending machine assembly 400 or transaction, and then embed a URL with identifiers linking to the specific vending machine assembly's product interface 112. The codes may be updated periodically or per-session to enhance security. The codes may be displayed on the display 206 of the electronic vending controller 106 and/or may be printed on labels affixed to the vending machine assembly 400.

The visitor log tracking 508 includes software instructions for aggregating user information, tracking user information, and identifying metrics based on the user information. The visitor log tracking 508 collects anonymized data, including transaction timestamps, product selections, and optional demographic inputs. The optional demographic inputs may be provided by way of an account for the device aggregation platform 104, and may include metrics such as age range, sex, location, and so forth. The visitor log tracking 508 employs statistical analysis or artificial intelligence and machine learning (AI/ML) to identify peak sales periods, product popularity, and customer trends. The visitor log tracking 508 generates reports for operators to optimize inventory and product placement.

The visitor log tracking 508 may be leveraged to determine what dates, days of the week, and times of day are most successful for disbursing products from the assembly 400. The visitor log tracking 508 may be further leveraged to determine which products are most popular and may further be leveraged to determine which human demographics are more likely to purchase certain types of products.

The inventory management 510 tracks current inventory levels in vending machines and may generate recommended orders and/or automatically place replenishment orders for vending machine products. The inventory management 510 may rely upon inventory sensor data (see, e.g., 224a-224n) output by vending machines and forwarded to the device aggregation server 102 via the electronic vending controller 106. The inventory management 510 utilizes the inventory sensor data to predict current inventory levels of various vending machine products. The inventory management 510 identifies which products are the most popular and provides a recommendation when certain products need to be replaced. The inventory management 510 includes maintaining a real-time database synced with each vending machine to update stock levels. The inventory management 510 may trigger scheduling 502 and notification generation 504 when inventory thresholds are breached.

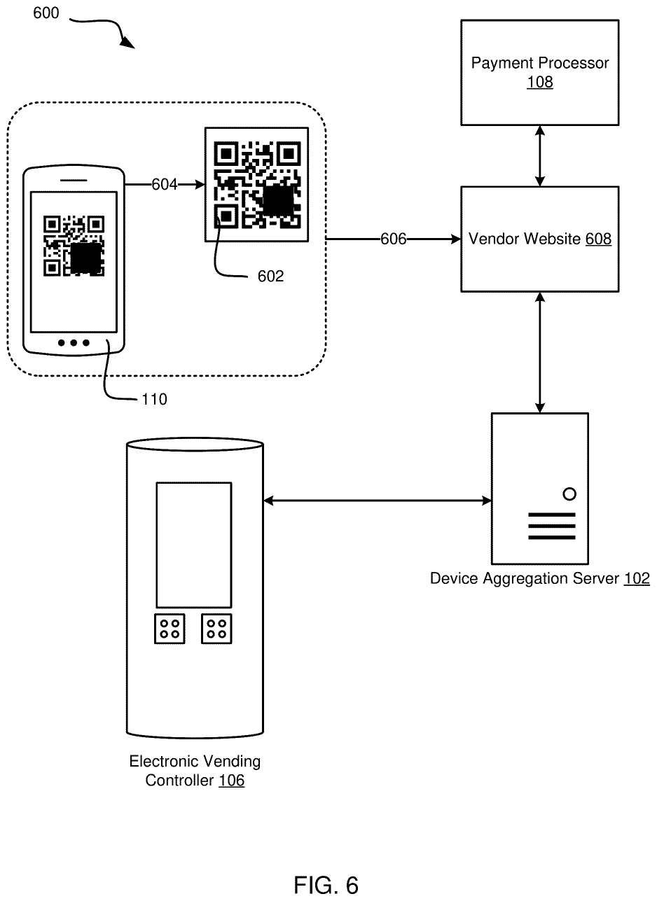

FIG. 6 is a schematic diagram of a system and process flow 600 for cloud-based or remote shopping for products available at an electronic bulk vending machine assembly. The process flow 600 may be performed by a user when the user is physically located near the electronic bulk vending machine assembly. The user may utilize a personal device 110 connected to the Internet to interact with an electronic commerce interface to select a product, pay for a product, and then initiate instructions for the product to be unlocked or disbursed from the electronic bulk vending machine assembly.

The process flow 600 begins with a personal device 110 scanning at 604 a scannable code 602. The scannable code 602 may be printed and affixed to the electronic bulk vending machine assembly 600. In some instances, the scannable code 602 is rendered on a display 206 of the assembly. The process flow 600 includes automatically redirecting at 606 the personal device 110 to a vendor website 608 in response to the personal device 110 scanning at 604. The vendor website 608 may be operated by a third-party or may be operated by the device aggregation server 102. The vendor website 608 may be specific to one location of an electronic bulk vending machine assembly or may include information for multiple separate locations that includes one or more electronic bulk vending machine assemblies. The vendor website 608 may communicate with one or more of a third-party payment processor 108 or the device aggregation server 102. The device aggregation server 102 communicates with the electronic vending controller 106.

Upon scanning the scannable code 602 at 604, the personal device 110 may redirect at 606 to the vendor website 608 to display the product interface 112 with real-time inventory. If a product is out of stock, the product may be greyed out with a notification. Users may select multiple products or schedule future disbursements. The third-party processor 108 may be utilized for payment processing, and may support methods like credit card payment, bank payment, mobile wallets, and so forth. The third-party processor 108 may prompt a retry if payment fails to process. Post-payment, the device aggregation server 108 may verify inventory before instructing the electronic vending controller 106 to disburse products. If actuation fails, and the products are not successfully disbursed, then the device aggregation server 108 may automatically initiate a payment refund.

The scannable code 602 may be any scannable figure or code that is readable by a device. In an embodiment, the scannable code 602 is a two-dimensional barcode such as a quick response (QR) code. The two-dimensional barcode can be digitally scanned by a camera or other sensor on the personal device 110. In an embodiment, the scannable code 602 is designed to appear like a graphic or image and the two-dimensional barcode is integrated or “hidden” in the image. The scannable code 602 may include multiple squares that can be read by the image sensor of the personal device 110.

In an embodiment where the scannable code 602 is a QR code, the code includes three large squares (the three large squares can be seen in the upper-left, lower-left, and upper-right corners of the example scannable code 602 shown in FIG. 6) that serve as alignment targets while a smaller square in a remaining corner of the scannable code 602 (the smaller square can be seen near the lower-right corner of the example scannable code 602 shown in FIG. 6) serves to normalize the angle with which the image sensor hits the scannable code 602. The remaining area of the scannable code 602 is the actual data that is converted into binary code by the personal device 110. The scannable code 602 may include many characters worth of data. In an example where the scannable code 602 is a 117-pixel square, the code may hold 1852 characters of data.

In an embodiment, an image sensor of the personal device 110 is directed to scan the scannable code 602, and the scannable code 602 includes instructions for the personal device 110 to connect to the vendor website 608. A processor of the personal device 110 may execute the instructions stored in the scannable code 602 to automatically connect at 606 to the vendor website 608.

In an example use-case, the device aggregation server 102 generates the scannable code 602 and causes the scannable code to be rendered on a display 206 of the assembly 600. The device aggregation server 102 generates the scannable code 602 to redirect a user to the product interface 112, which is rendered on the vendor website 608. A user scans the scannable code 602 with a personal device 110 such as a mobile phone, and then the mobile phone is automatically redirected to open the vendor website 608. The user may then browse the product interface 112 on the vendor website 608 to identify products available at the assembly 600 and to further identify the pricing for those products. The user may interact with the vendor website 608 to select a desired product and then select a form of payment. Depending on the selected form of payment, the personal device 110 may be redirected to load a payment page of a third-party payment processor 108 or may perform payment directly through the vendor website 608. If payment is processed successfully, then a server executing instructions for the vendor website 608 will communicate with the device aggregation server 102 to indicating that vending is approved for the assembly 600. The device aggregation server 102 communication with the electronic vending controller 106 to authorize vending of one or more products managed by the electronic vending controller 106. The electronic vending controller 106 may then automatically disburse one or more products from one or more of the vending machines (see, e.g., 202), may unlock one or more of the vending machines to enable a user to initiate disbursement, or may instruct the user to select a vending machine and initiate disbursement. The electronic vending controller 106 returns a status code to the device aggregation server 102 to indicate that vending was successful or unsuccessful. The device aggregation server 102 returns a status code to the vendor website 608 indicating the vending was successful or unsuccessful. The vendor website 608 is updated to provide a status update to the personal device 110 indicating whether the vending was successful or unsuccessful. The vendor website 608 may then prompt the user to provide feedback.

Communications between the personal device 110, device aggregation server 102, and electronic vending controller 106 may be secured using encryption protocols such as HTTPS or TLS. This may include the generation of authentication tokens to prevent unauthorized actuation of the electronic vending controller 106, and further to prevent data breaches.

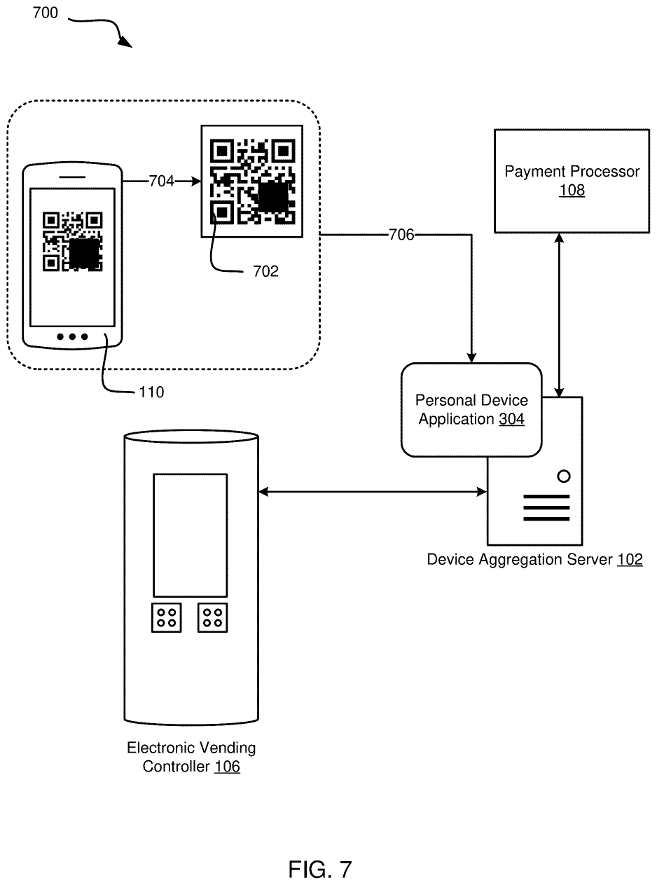

FIG. 7 is a schematic diagram of a system and process flow 700 for cloud-based or remote shopping for products available at an electronic bulk vending machine assembly. The process flow 700 may be performed by a user when the user is physically located near the electronic bulk vending machine assembly. The user may utilize a personal device 110 connected to the Internet to interact with an electronic commerce interface to select a product, pay for a product, and then initiate instructions for the product to be unlocked or disbursed from the electronic bulk vending machine assembly.

The process flow 700 includes similarities to the process flow 600 first described in connection with FIG. 6. However, the process flow 700 illustrated in FIG. 7 causes the personal device 110 to redirect to an application 708 or website that is rendered by the device aggregation server 102, rather than a vendor website 608 that may or may not be rendered by the device aggregation server 102, as shown in FIG. 6.

The process flow 700 is initiated with a user scanning at 704 a scannable code 702 with a personal device 110. The scannable code 702 instructs the personal device 110 to automatically redirect at 706 to a personal device application 304 or a web page rendered on a web browser. The personal device application 304 or website is rendered by the device aggregation server 102. Like the example use-case described above in connection with FIG. 6, the user may interact with the product interface 112 rendered on the application 708 or website to select a product, initiate payment for the product, providing payment information, and initiate execution of payment for the product. If payment is successful, then the device aggregation server 102 communicates with the electronic vending controller 106 and instructs the electronic vending controller 106 to automatically disburse products or automatically unlock one or more vending machines to enable user-initiated disbursement of products.

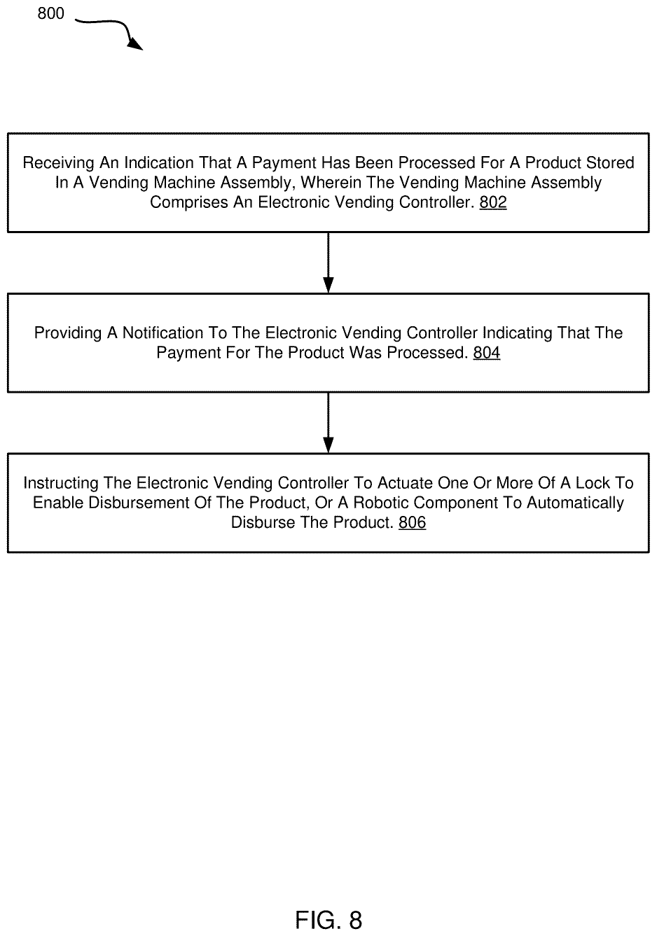

FIG. 8 is a schematic diagram of a method 800 for automatic disbursement of products from a vending machine assembly. The method 800 may be performed by the device aggregation server 102. The device aggregation server 102 may be in communication with a plurality of independent vending machine assemblies located at a plurality of different geographic locations.

The method 800 includes receiving at 802 an indication that a payment has been processed for a product stored in a vending machine assembly, wherein the vending machine assembly comprises an electronic vending controller. The method 800 includes providing at 804 a notification to the electronic vending controller indicating that the payment for the product was processed. The method 800 includes instructing at 806 the electronic vending controller to actuate one or more of a lock to enable disbursement of the product, or a robotic component to automatically disburse the product.

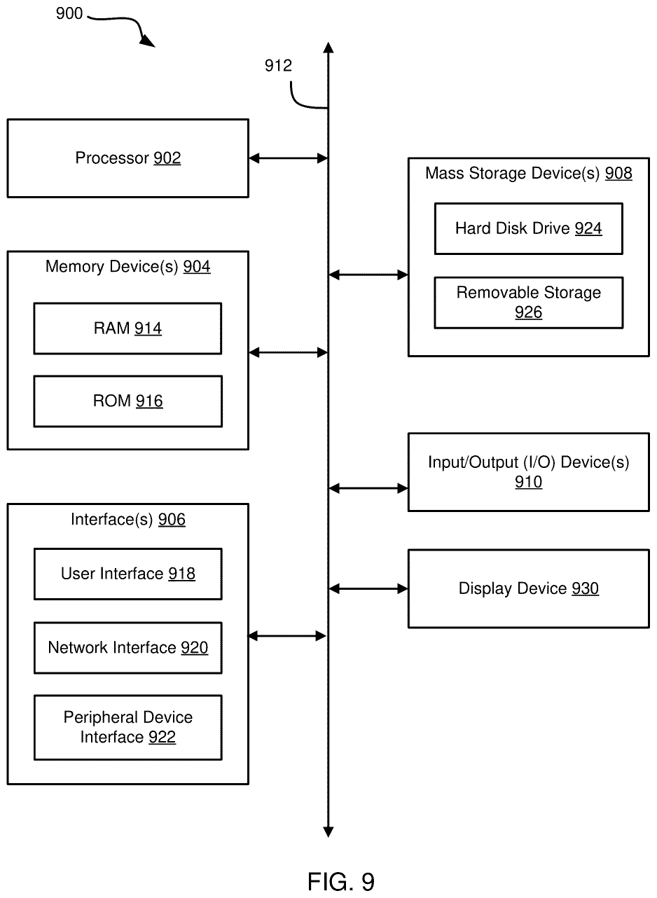

Referring now to FIG. 9, a block diagram of an example computing device 900 is illustrated. Computing device 900 may be used to perform various procedures, such as those discussed herein. Computing device 900 can perform various monitoring functions as discussed herein, and can execute one or more application programs, such as the application programs or functionality described herein. Computing device 900 can be any of a wide variety of computing devices, such as a desktop computer, in-dash computer, vehicle control system, a notebook computer, a server computer, a handheld computer, tablet computer and the like.

Computing device 900 includes one or more processor(s) 904, one or more memory device(s) 904, one or more interface(s) 906, one or more mass storage device(s) 908, one or more Input/output (I/O) device(s) 910, and a display device 930 all of which are coupled to a bus 912. Processor(s) 904 include one or more processors or controllers that execute instructions stored in memory device(s) 904 and/or mass storage device(s) 908. Processor(s) 904 may also include distinct types of computer-readable media, such as cache memory.

Memory device(s) 904 include various computer-readable media, such as volatile memory (e.g., random access memory (RAM) 914) and/or nonvolatile memory (e.g., read-only memory (ROM) 916). Memory device(s) 904 may also include rewritable ROM, such as Flash memory.

Mass storage device(s) 908 include various computer readable media, such as magnetic tapes, magnetic disks, optical disks, solid-state memory (e.g., Flash memory), and so forth. As shown in FIG. 9, a particular mass storage device 908 is a hard disk drive 924. Various drives may also be included in mass storage device(s) 908 to enable reading from and/or writing to the various computer readable media. Mass storage device(s) 908 include removable media 926 and/or non-removable media.

I/O device(s) 910 include various devices that allow data and/or other information to be input to or retrieved from computing device 900. Example I/O device(s) 910 include cursor control devices, keyboards, keypads, microphones, monitors or other display devices, speakers, printers, network interface cards, modems, and the like.

Display device 930 includes any type of device capable of displaying information to one or more users of computing device 900. Examples of display device 930 include a monitor, display terminal, video projection device, and the like.

Interface(s) 906 include various interfaces that allow computing device 900 to interact with other systems, devices, or computing environments. Example interface(s) 906 may include any number of different network interfaces 920, such as interfaces to local area networks (LANs), wide area networks (WANs), wireless networks, and the Internet. Other interface(s) include user interface 918 and peripheral device interface 922. The interface(s) 906 may also include one or more user interface elements 918. The interface(s) 906 may also include one or more peripheral interfaces such as interfaces for printers, pointing devices (mice, track pad, or any suitable user interface now known to those of ordinary skill in the field, or later discovered), keyboards, and the like.

Bus 912 allows processor(s) 904, memory device(s) 904, interface(s) 906, mass storage device(s) 908, and I/O device(s) 910 to communicate with one another, as well as other devices or components coupled to bus 912. Bus 912 represents one or more of several types of bus structures, such as a system bus, PCI bus, IEEE bus, USB bus, and so forth.

In the above disclosure, reference has been made to the accompanying drawings, which form a part hereof, and in which is shown by way of illustration specific implementations in which the disclosure may be practiced. It is understood that other implementations may be utilized, and structural changes may be made without departing from the scope of the present disclosure. References in the specification to “one embodiment,” “an embodiment,” “an example embodiment,” a., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly distinct kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium, which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general-purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, televisions, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to conduct one or more of the systems and procedures described herein. Certain terms are used throughout the description and claims to refer to particular system components. The terms “modules” and “components” are used in the names of certain components to reflect their implementation independence in software, hardware, circuitry, sensors, or the like. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein purposes of illustration and are not intended to be limiting. Embodiments of the present disclosure may be implemented in further types of devices, as would be known to persons skilled in the relevant art(s).

### Examples

The following examples pertain to further embodiments.

Example 1 is a method. The method includes receiving an indication that a payment has been processed for a product stored in a vending machine assembly, wherein the vending machine assembly comprises an electronic vending controller in communication with a network. The method includes providing a notification to the electronic vending controller indicating that the payment was processed. The method includes instructing the electronic vending controller to actuate one or more of a lock to enable disbursement of the product, or to actuate a robotic component to automatically disburse the product.

Example 2 is a method as in Example 1, further comprising rendering a product interface, wherein the product interface is rendered on a user interface displayed on one or more of a website, an application, or a display installed on the vending machine assembly.

Example 3 is a method as in any of Examples 1-2, wherein rendering the product interface comprises identifying product inventory currently available at the vending machine assembly, wherein the product interface display the inventory currently available at the vending machine assembly.

Example 4 is a method as in any of Examples 1-3, wherein rendering the product interface comprises communicating with a vendor server, wherein the vendor server manages product inventory for the vending machine assembly.

Example 5 is a method as in any of Examples 1-4, further comprising receiving a product selection indicating that a user has selected the product, wherein the product selection is provided by way of the product interface.

Example 6 is a method as in any of Examples 1-5, further comprising processing payment for the product selection, wherein processing payment comprises communicating with a third-party payment processor.

Example 7 is a method as in any of Examples 1-6, further comprising receiving an indication from the third-party payment processor that the payment for the product selection was successfully processed.

Example 8 is a method as in any of Examples 1-7, further comprising, in response to receiving the indication from the third-party payment processor indicating that the payment for the product selection was successfully processed, providing the notification to the electronic vending controller indicating the payment was processed.

Example 9 is a method as in any of Examples 1-8, wherein the vending machine assembly comprises a plurality of independent vending machines, and wherein each of the plurality of independent vending machines is actuated by the electronic vending controller.

Example 10 is a method as in any of Examples 1-9, wherein at least a portion of the plurality of independent vending machines is a gravity-fed vending machine comprising a receptable for storing a plurality of products, and further comprises a disbursement chute for disbursing the plurality of products.

Example 11 is a method as in any of Examples 1-10, wherein each of the plurality of independent vending machines comprises an electronically-actuated motor for rotating a rotatable means for opening a lock that prevents the plurality of products from entering the disbursement chute.

Example 12 is a method as in any of Examples 1-11, wherein electronic vending controller is in electronic communication with the electronically-actuated motor for each of the plurality of independent vending machines.

Example 13 is a method as in any of Examples 1-12, further comprising generating a scannable code, wherein the scannable code instructs a personal computing device to automatically redirect to a vendor website, and wherein the vendor website comprises a product interface for shopping products available from the vending machine assembly.

Example 14 is a system comprising one or more processors configurable to execute instructions stored in non-transitory computer readable storage medium, wherein the instructions comprise any of the method steps recited in any of Examples 1-13.

Example 15 is non-transitory computer readable storage medium storing instructions for execution by one or more processors, wherein the instructions comprise any of the method steps recited in any of Examples 1-13.

Example 16 is a method. The method includes receiving an indication that a payment has been processed for a product stored in a vending machine, wherein the vending machine is one of a plurality of vending machines in electronic communication with an electronic vending controller. The method includes providing a notification to the electronic vending controller indicating the payment for the product was processed. The method includes instructing the electronic vending controller to actuate a disbursement mechanism for the vending machine to automatically disburse the product. The method is such that there is bi-directional electronic communication between the remote server and the electronic vending controller, such that the remote server tracks inventory for the plurality of vending machines.

Example 17 is an method as in Example 16, further comprising rendering a graphical user interface of a customer platform associated with the plurality of vending machines in electronic communication with the electronic vending controller, wherein the customer platform comprises: an indication of current inventory available in the plurality of vending machines; an indication of pricing for the current inventory available in the plurality of vending machines; and an electronic commerce interface enabling a customer to purchase one or more products from the plurality of vending machines.

Example 18 is a method as in any of Examples 16-17, further comprising rendering a graphical user interface of an administrator platform associated with the plurality of vending machines in electronic communication with the electronic vending controller, wherein the administrator platform comprises: an indication of current inventory available in the plurality of vending machines; an indication of pricing for the current inventory available in the plurality of vending machines; an indication of sensor data output by one or more of the electronic vending controller or any of the plurality of vending machines; and an indication of operational issues or maintenance alerts for the electronic vending controller or any of the plurality of vending machines.

Example 19 is a method as in any of Examples 16-18, wherein the electronic vending controller comprises a microcontroller executing bidirectional communication with a remote server, and wherein the method further comprises rendering, by the remote server, a customer platform to be displayed on one or more of: a display for the electronic vending controller; an application; or a web browser.

Example 20 is a method as in any of Examples 16-19, wherein rendering the customer platform comprises establishing an Application Program Interface (API) integration with a third-party payment processor to enable web-based payment for any products stored in the plurality of vending machines.

Example 21 is a method as in any of Examples 16-20, wherein receiving the indication that the payment has been processed comprises receiving confirmation from a third-party payment processor that the payment for the product has been executed.

Example 22 is a method as in any of Examples 16-21, further comprising receiving operational sensor data from the electronic vending controller indicating a current health of the electronic vending controller or any of the plurality of vending machines, wherein the sensor data comprises one or more of: a temperature output by a temperature sensor installed in any of the plurality of vending machines or the electronic vending controller; or a vibration reading output by a vibration sensor installed in any of the plurality of vending machines or the electronic vending controller.

Example 23 is a method as in any of Examples 16-22, further comprising receiving inventory sensor data from the electronic vending controller, wherein the inventory sensor data comprises one or more of: a product weight output by a weight sensor installed in any of the plurality of vending machines; an indication that an infrared beam sensor confirmed a product was disbursed from any of the plurality of vending machines; or an image of products stored within any of the plurality of vending machines.

Example 24 is a method as in any of Examples 16-23, further comprising receiving inventory sensor data from the electronic vending controller, wherein the inventory sensor data comprises information output by one or more of a magnetic sensor, a radio-frequency identification sensor, or a near field communication sensor indicating that a product has been disbursed from any of the plurality of vending machines.

Example 25 is a method as in any of Examples 16-24, wherein instructing the electronic vending controller to actuate the disbursement mechanism comprises instructing a microcontroller of the electronic vending controller to send an electrical pulse or digital command to a motor installed in the vending machine to cause the vending machine to disburse the product.

Example 26 is a method as in any of Examples 16-25, wherein instructing the electronic vending controller to actuate the disbursement mechanism comprises instructing a microcontroller of the electronic vending controller to send an electrical pulse or digital comment to a solenoid installed in the vending machine to cause the vending machine to disburse the product.

Example 27 is a method as in any of Examples 16-26, further comprising: receiving temperature sensor data from the electronic vending controller indicating a current temperature of any of the plurality of vending machines; determining the temperature sensor data exceeds a temperature threshold for optimal operation of the plurality of vending machines; and generating a notification for an administrator of the electronic vending controller indicating that at least one of the plurality of vending machines is overheated.

Example 28 is a method as in any of Examples 16-27, further comprising: tracking current inventory of the plurality of vending machines based upon inventory data output by a plurality of inventory sensors installed in the plurality of vending machines; determining that current product inventory of at least one of the plurality of vending machines fails to meet an inventory threshold; and generating a notification for an administrator of the electronic vending controller indicating the current product inventory of the at least one of the plurality of vending machines fails to meet the inventory threshold.

Example 29 is a method as in any of Examples 16-28, wherein the payment is processed by way of one or more of credit card payment, mobile wallet payment, or bank transfer payment.

Example 30 is a method as in any of Examples 16-29, wherein the plurality of vending machines comprises one or more of: a gravity-feed vending machine comprising a gate control; a spiral dispenser; a drop shelf system; a pusher mechanism; a conveyer belt system; a lift system; or a rotating drum system.

Example 31 is a method as in any of Examples 16-30, wherein at least one of the plurality of vending machines comprises a gravity-feed vending machine system comprising a gate control.

Example 32 is a method as in any of Examples 16-31, further comprising: rendering a customer interface for the electronic vending controller, wherein the customer interface comprises an indication of current inventory available across the plurality of vending machines; receiving a product selection from a user, wherein the product selection comprises the product stored in the vending machine; and initiating payment for the product by way of an Application Program Interface integration with a third-party payment processor.

Example 33 is a method as in any of Examples 16-32, further comprising: receiving an indication from the electronic vending controller that the disbursement mechanism for the vending machine successfully disbursed the product; and decrementing an inventory quantity for the vending machine based upon the successful disbursement of the product.

Example 34 is a method as in any of Examples 16-33, further comprising: receiving an indication from the electronic vending controller that the disbursement mechanism for the vending machine did not successfully disburse the product; and automatically initiating a payment refund based upon the unsuccessful disbursement of the product.

Example 35 is a system. The system includes an electronic vending controller in communication with a plurality of vending machines. The system includes a remote server in communication with the electronic vending controller, wherein the server executes instructions stored in non-transitory computer readable storage medium comprising any of the method steps described in any of Examples 1-34.

Example 36 is non-transitory computer readable storage medium storing instructions for execution by one or more processors, the instructions comprising any of the method steps described in any of Examples 1-34.

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A method comprising:
receiving by a remote server an indication that a payment has been processed for a product stored in a vending machine, wherein the vending machine is one of a plurality of vending machines in electronic communication with an electronic vending controller;
providing a notification to the electronic vending controller indicating the payment for the product was processed; and
instructing the electronic vending controller to actuate a disbursement mechanism for the vending machine to automatically disburse the product;
wherein there is bi-directional electronic communication between the remote server and the electronic vending controller, such that the remote server tracks inventory for the plurality of vending machines.

2. The method of claim 1, further comprising rendering a graphical user interface of a customer platform associated with the plurality of vending machines in electronic communication with the electronic vending controller, wherein the customer platform comprises:
an indication of current inventory available in the plurality of vending machines;
an indication of pricing for the current inventory available in the plurality of vending machines; and
an electronic commerce interface enabling a customer to purchase one or more products from the plurality of vending machines.

3. The method of claim 1, further comprising rendering a graphical user interface of an administrator platform associated with the plurality of vending machines in electronic communication with the electronic vending controller, wherein the administrator platform comprises:
an indication of current inventory available in the plurality of vending machines;
an indication of pricing for the current inventory available in the plurality of vending machines;
an indication of sensor data output by one or more of the electronic vending controller or any of the plurality of vending machines; and
an indication of operational issues or maintenance alerts for the electronic vending controller or any of the plurality of vending machines.

4. The method of claim 1, wherein the electronic vending controller comprises a microcontroller executing bidirectional communication with the remote server, and wherein the method further comprises rendering, by the remote server, a customer platform to be displayed on one or more of:
a display for the electronic vending controller;
an application; or
a web browser.

5. The method of claim 4, wherein rendering the customer platform comprises establishing an Application Program Interface (API) integration with a third-party payment processor to enable web-based payment for any products stored in the plurality of vending machines.

6. The method of claim 1, wherein receiving the indication that the payment has been processed comprises receiving confirmation from a third-party payment processor that the payment for the product has been executed.

7. The method of claim 1, further comprising receiving operational sensor data from the electronic vending controller indicating a current health of the electronic vending controller or any of the plurality of vending machines, wherein the sensor data comprises one or more of:
a temperature output by a temperature sensor installed in any of the plurality of vending machines or the electronic vending controller; or
a vibration reading output by a vibration sensor installed in any of the plurality of vending machines or the electronic vending controller.

8. The method of claim 1, further comprising receiving inventory sensor data from the electronic vending controller, wherein the inventory sensor data comprises one or more of:
a product weight output by a weight sensor installed in any of the plurality of vending machines;
an indication that an infrared beam sensor confirmed a product was disbursed from any of the plurality of vending machines; or
an image of products stored within any of the plurality of vending machines.

9. The method of claim 1, further comprising receiving inventory sensor data from the electronic vending controller, wherein the inventory sensor data comprises information output by one or more of a magnetic sensor, a radio-frequency identification sensor, or a near field communication sensor indicating that a product has been disbursed from any of the plurality of vending machines.

10. The method of claim 1, wherein instructing the electronic vending controller to actuate the disbursement mechanism comprises instructing a microcontroller of the electronic vending controller to send an electrical pulse or digital command to a motor installed in the vending machine to cause the vending machine to disburse the product.

11. The method of claim 1, wherein instructing the electronic vending controller to actuate the disbursement mechanism comprises instructing a microcontroller of the electronic vending controller to send an electrical pulse or digital comment to a solenoid installed in the vending machine to cause the vending machine to disburse the product.

12. The method of claim 1, further comprising:
receiving temperature sensor data from the electronic vending controller indicating a current temperature of any of the plurality of vending machines;
determining the temperature sensor data exceeds a temperature threshold for optimal operation of the plurality of vending machines; and
generating a notification for an administrator of the electronic vending controller indicating that at least one of the plurality of vending machines is overheated.

13. The method of claim 1, further comprising:
tracking current inventory of the plurality of vending machines based upon inventory data output by a plurality of inventory sensors installed in the plurality of vending machines;
determining that current product inventory of at least one of the plurality of vending machines fails to meet an inventory threshold; and
generating a notification for an administrator of the electronic vending controller indicating the current product inventory of the at least one of the plurality of vending machines fails to meet the inventory threshold.

14. The method of claim 1, wherein the payment is processed by way of one or more of credit card payment, mobile wallet payment, or bank transfer payment.

15. The method of claim 1, wherein the plurality of vending machines comprises one or more of:
a gravity-feed vending machine comprising a gate control;
a spiral dispenser;
a drop shelf system;
a pusher mechanism;
a conveyer belt system;
a lift system; or
a rotating drum system.

16. The method of claim 1, wherein at least one of the plurality of vending machines comprises a gravity-feed vending machine system comprising a gate control.

17. The method of claim 1, further comprising:
rendering a customer interface for the electronic vending controller, wherein the customer interface comprises an indication of current inventory available across the plurality of vending machines;
receiving a product selection from a user, wherein the product selection comprises the product stored in the vending machine; and
initiating payment for the product by way of an Application Program Interface integration with a third-party payment processor.

18. The method of claim 1, further comprising:
receiving an indication from the electronic vending controller that the disbursement mechanism for the vending machine successfully disbursed the product; and
decrementing an inventory quantity for the vending machine based upon the successful disbursement of the product.

19. The method of claim 1, further comprising:
receiving an indication from the electronic vending controller that the disbursement mechanism for the vending machine did not successfully disburse the product; and
automatically initiating a payment refund based upon the unsuccessful disbursement of the product.

20. A system comprising:
an electronic vending controller in communication with a plurality of vending machines; and
a remote server in communication with the electronic vending controller, wherein the server executes instructions stored in non-transitory computer readable storage medium comprising:
receiving an indication that a payment has been processed for a product stored in a first vending machine of the plurality of vending machines
providing a notification to the electronic vending controller indicating the payment for the product was processed; and
instructing the electronic vending controller to actuate a disbursement mechanism for the first vending machine to automatically disburse the product.
